(19) United States
(12) Patent Application Publication
(10) Pub. No.: US 2017/0225812 A1
(43) Pub. Date: Aug. 10, 2017

(54) STACKING APPARATUS AND METHOD FOR BINDING OPERATIONS

(71) Applicant: JOHNSEN MACHINE COMPANY LIMITED, Burlington (CA)

(72) Inventors: Ole Johnsen, Burlington (CA); Denis Trottier, Mississauga (CA); Wojciech Kowalczuk, Ancaster (CA); Derek Savich, Hamilton (CA)

(21) Appl. No.: 15/429,101

(22) Filed: Feb. 9, 2017

Related U.S. Application Data
(60) Provisional application No. 62/293,192, filed on Feb. 9, 2016.

(51) Int. Cl. B65B 13/02; B65G 11/02; B65B 35/24; B65G 11/20; B65B 35/50; B65B 39/00; B65G 15/00; B65G 11/18

(52) U.S. Cl. CPC B65B 13/02; B65G 15/00; B65G 11/023; B65G 11/183; B65G 11/203; B65B 35/50; B65B 39/007; B65B 35/243

(57) ABSTRACT

A baling machine may be adapted for use in stacking packages to support binding operations such as strapping, banding or wrapping. A stack of filled packages is accumulated in a chute that is disposed above and in registration with a conveyor, with a baseplate disposed above the conveyor in registration with the chute. The stack of filled packages is released from the chute into a magazine disposed between and in registration with the chute and the baseplate, so that the stack of filled packages rests on the baseplate inside the magazine. The magazine then moves in a conveyor-forward direction to move the stack of filled packages off the baseplate onto a conveyor surface of the conveyor, and the stack of filled packages is released from the magazine to move forward along the conveyor toward a binding machine, such as a strapping machine, banding machine or wrapping machine.

### TECHNICAL FIELD

The present disclosure relates to baling machines.

### BACKGROUND OF THE INVENTION

Many types of products are sold in relatively small packages, such as for example potatoes which are commonly sold in bags of five or ten pounds, and ice which is commonly sold in ten pound bags. Handling and shipping products in packages of such a small size increases costs and so it is common to place a number of small packages of product into a larger bag weighing between forty and sixty pounds. This procedure is known as “baling” and the bag is known as a “bale bag”.

Baling may be done manually. A hoop is used to suspend an open bale bag and packages of product are dropped one at a time into the bale bag. When full, the bag is tied shut. Manual baling does reduce handling during shipping but it is a labour intensive practice.

An alternative to manual baling is to use an automatic baling machine or “baler”. Typically such balers elevate the packages lengthwise on a conveyor belt before unloading them sequentially sideways into a vertical chute until a group of a predetermined number are stacked side-by-side on trap doors at the bottom of the chute. The doors are then opened and the group of packages in the chute drop into an open bale bag suspended below the chute. A pusher plate coupled to a reciprocating arm on the baler moves the full bag onto an exit conveyer, which moves the bag to, for example, an automatic bag closing machine. Examples of such baling machines include those taught by U.S. Pat. Nos. 5,117,614 and 5,127,212 to Johnsen, the teachings of which are hereby incorporated by reference. A commercially available example of a baler is the Adjustable Master Ice Baler offered as product number IB-1008 by Johnsen Machine Company Ltd., having an address at 3470 Mainway, Burlington, Ontario, Canada L7M 1A8. Commonly this type of baling machine provides a dramatic increase in speed and a significant saving in labour over manual baling.

While the use of bale bags can reduce costs when compared to individually handling and shipping the smaller packages bundled into the bale bags, the bags themselves are not costless. An alternative to bale bags is to bind packages together, and the binding material may be cheaper than the bale bags. However, any such cost savings must be offset against the increased capital cost of new equipment required to assemble bags for binding instead of baling.

### SUMMARY

Broadly speaking, the present disclosure describes apparatus and methods relating to the adaptation of a baling machine for use in stacking packages to support binding operations. A magazine may be used to receive a stack of packages from a baling machine and assist in transferring the stack to a binding machine. The term “binding machine”, as used herein, refers to any machine which can bind the individual packages in a stack together into a single integral unit, and includes a strapping machine, a banding machine and a wrapping machine such as an orbital wrapping machine.

In one aspect, a method for binding a plurality of filled packages comprises accumulating a stack of filled packages in a chute. The chute is disposed above and in registration with a conveyor, and a baseplate is disposed above the conveyor in registration with the chute. The method further comprises releasing the stack of filled packages from the chute into a magazine. The magazine is disposed between the chute and the baseplate and is in registration with the chute and the baseplate when the stack of filled packages is released from the chute, so that the stack of filled packages rests on the baseplate inside the magazine. The method further comprises moving the magazine in a conveyor-forward direction to move the stack of filled packages off the baseplate onto a conveyor surface of the conveyor, and releasing the stack of filled packages from the magazine to move along the conveyor in the conveyor-forward direction toward a binding machine.

In another aspect, a magazine for transferring a stack of bags from an accumulator chute to a conveyor comprises a partial tube forming a channel having a longitudinally extending discharge opening. The channel extends between an open superior end of the partial tube and an open inferior end of the partial tube. A gate is movably carried by the partial tube so as to be movable, relative to the partial tube, between a closed position in which the discharge opening is obstructed by the gate and an open position in which the discharge opening is unobstructed by the gate. At least one actuator acts between the partial tube and the gate and is adapted to move the gate between the open position and the closed position. An arm mounting fixture on the partial tube is adapted for mounting the magazine to a reciprocating arm of a baling machine.

In some embodiments of the magazine, the gate is hinged to the partial tube.

In some embodiments of the magazine, the mounting fixture is disposed opposite the discharge opening.

An apparatus for binding a plurality of packages together comprises a baling machine, a baseplate spaced from and in registration with a lower opening of a chute of the baling machine, an exit conveyor and a magazine as described above. The magazine is mounted by way of the arm mounting fixture to a reciprocating arm of the baler so that the channel and the discharge opening extend substantially vertically and so that the magazine is movable, relative to the baler and the exit conveyor, between a receiving position and a discharge position. In the receiving position, the open superior end of the partial tube and the open inferior end of the partial tube are in registration with the baseplate and with the lower opening of the chute of the baler, and in the discharge position the open superior end of the partial tube and the open inferior end of the partial tube are out of registration with the baseplate and in registration with the exit conveyor.

In some embodiments, the exit conveyor comprises an upstream conveyor segment and a downstream conveyor segment, with the downstream conveyor segment being spaced from the upstream conveyor segment to define a binding gap between the upstream conveyor segment and the downstream conveyor segment. The apparatus may further comprise a binding machine positioned at the binding gap; the binding machine may be a strapping machine positioned so that a strap outlet of the strapping machine is in registration with the binding gap so that straps emitted by the strapping machine can pass through the binding gap.

### BRIEF DESCRIPTION OF THE DRAWINGS

These and other features will become more apparent from the following description in which reference is made to the appended drawings wherein:

FIG. 1 is an elevation view of an exemplary baling machine, shown in operation baling packages which enter by a conveyor into an entrance side of the machine, fall into a chute, and leave at the bottom on the exit side of the machine in a bale bag;

FIG. 2 is an isometric view of an upper part of the baling machine of FIG. 1 and showing details of a stop plate used to locate the packages and trap doors used to receive the packages and drop them sequentially;

FIG. 3A is a top isometric view of an exemplary apparatus for binding a plurality of packages together, comprising a baling machine, a magazine, a baseplate, an exit conveyor and a binding machine;

FIG. 3B is a top isometric view of the apparatus of FIG. 3A, with the baling machine shown in transparency;

FIGS. 4A and 5A are top isometric views of the apparatus of FIG. 3A with the baling machine removed and with the magazine in a receiving position;

FIGS. 4B and 5B are top isometric views of the apparatus of FIG. 3A with the baling machine removed and with the magazine in a discharge position;

FIGS. 6A to 6D are isometric views of the magazine of the apparatus of FIG. 3A, showing a door of the magazine in a closed position;

FIGS. 6E to 6H are elevation views of the magazine of the apparatus of FIG. 3A, showing the door of the magazine in a closed position;

FIGS. 6I and 6J are top and bottom plan views, respectively, of the magazine of the apparatus of FIG. 3A, showing the door of the magazine in the closed position;

FIGS. 7A to 7D are isometric views of the magazine of the apparatus of FIG. 3A, showing the door of the magazine in an open position;

FIGS. 7E to 7H are elevation views of the magazine of the apparatus of FIG. 3A, showing the door of the magazine in an open position;

FIGS. 7I and 7J are top and bottom plan views, respectively, of the magazine of the apparatus of FIG. 3A, showing the door of the magazine in the open position; and

FIGS. 8A to 8G show a method for binding a plurality of filled packages using the apparatus of FIG. 3A.

### DETAILED DESCRIPTION

Throughout the drawings, certain elements, such as electrical wiring, pneumatic and/or hydraulic tubing and the like have been omitted for simplicity of illustration. Placement and connection of such elements is within the capability of one skilled in the art, now informed by the present disclosure.

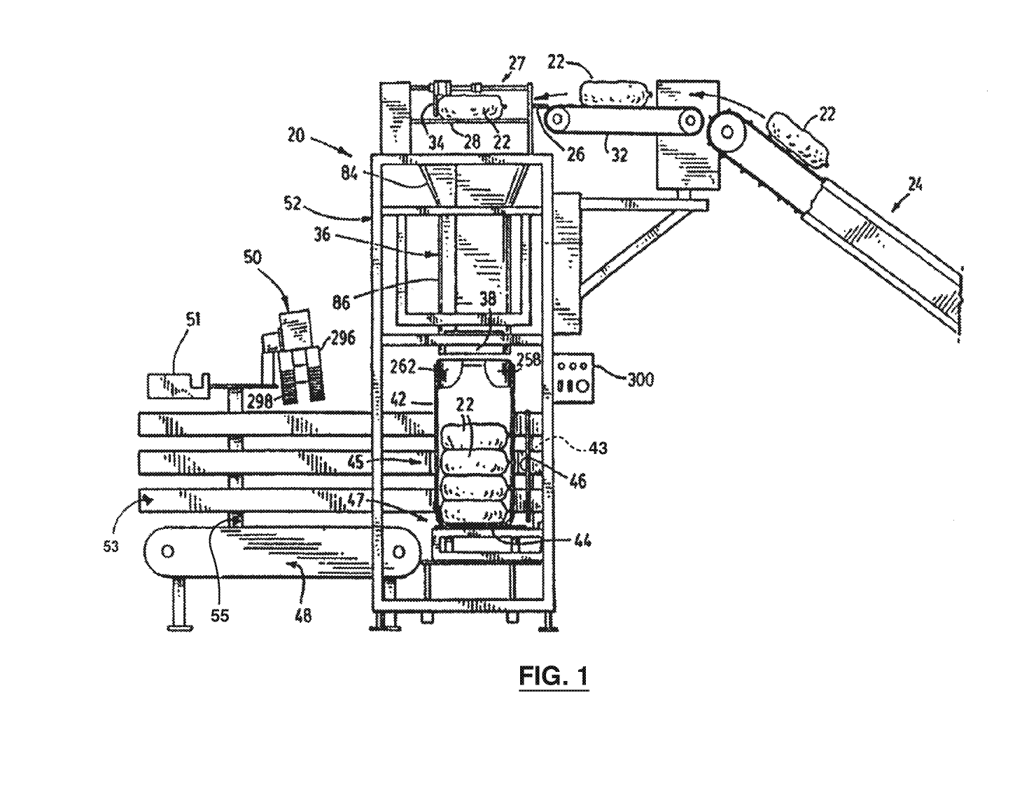

Reference is now made to FIG. 1, which shows an exemplary baling machine or “baler”. In FIG. 1, the baling machine, indicated generally by reference numeral 20, is supported by a rigid frame 52 that has vertical uprights that are connected to each other by horizontal cross members. The machine is controlled by a control system as indicated generally by numeral 300.

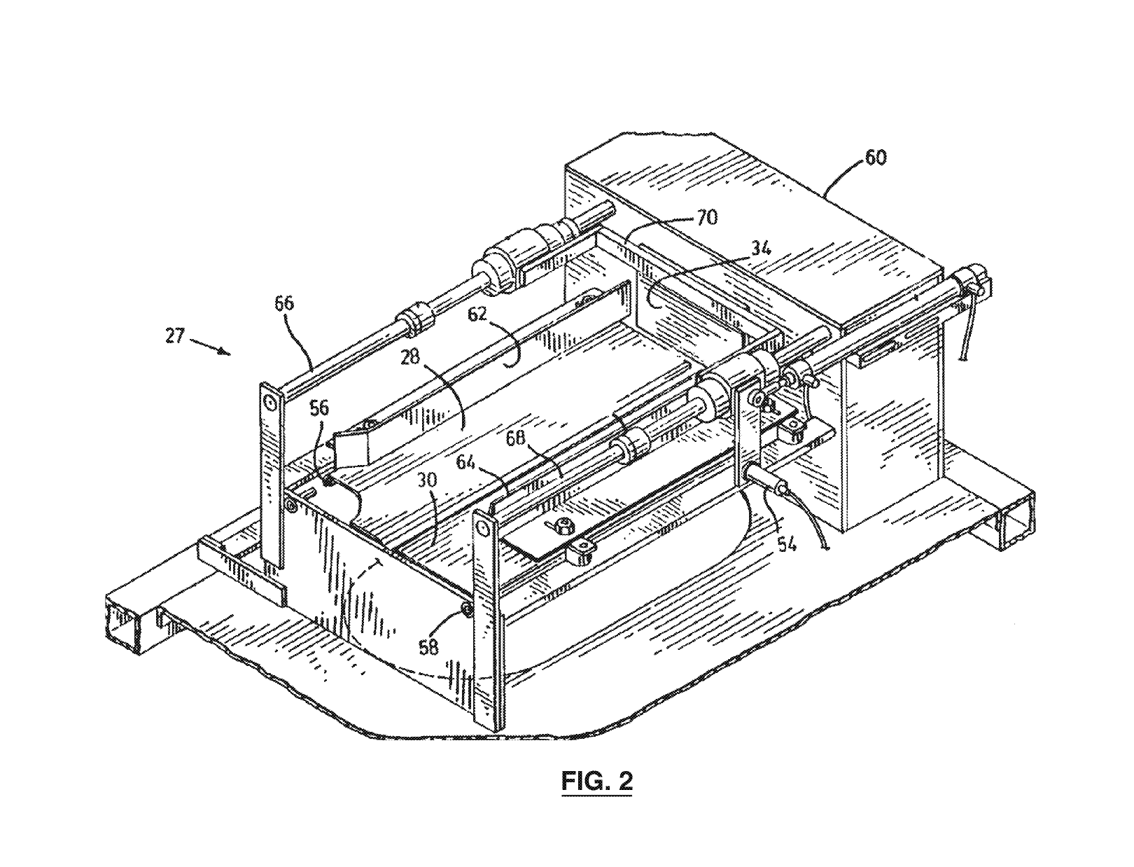

Continuing to describe FIG. 1, the packages 22 enter the baling machine 20 on an elevating conveyor 24. One at a time the packages run onto an intermediate conveyer 32 which increases the speed of the packages 22 so there is the required space between successive packages. The spacing is so that there is time for the upper trap doors 28 and 30 (FIG. 2) to be closed prior to the arrival of the next package. The packages 22 move over a connecting plate 26 onto the loading station 27. The packages 22 are positioned over the closed upper trap doors 28 and 30 by a vertical stop plate 34. The vertical stop plate 34 has a sensor 54 (FIG. 2) on one side of the upper trap doors 28, 30 to sense when a package 22 is present. This sensor 54 enables the control system 300 to open the upper trap doors 28, 30 and the packages 22 are dropped from the loading station 27 into a chute 36 located below the upper trap doors 28, 30 and which is closed at its lower end by lower trap doors 38. The chute 36 has a tapered upper portion 84 to funnel the falling packages and it converges to a tubular lower portion 86. The chute 36 may be of a fixed size or alternate embodiments may have an adjustable chute as described in U.S. Pat. No. 5,127,212 and corresponding Canadian Patent No. 1,306,224. In an embodiment where the chute 36 is adjustable, the chute 36 expands around a fixed central point so that it remains in alignment with the rest of the machine and so packages always travel along the same path.

Continuing to refer to FIG. 1, a specified number of packages is set by the user with respect to the number of packages per bale bag, as usually defined by a weight. When the select number of packages to fill a bale bag have accumulated in the chute 36, the lower trap doors 38 open and the group of packages can fall into the bag loading station 45 below where a bale bag 42 is held open. There is a time delay to ensure the package has cleared the lower trap doors 38 before they close. The bale bag is held open by grips 262, 258 and supported by support bracket spacing that can be adjusted on the lower horizontal frame so that bale bags with different size openings can be accommodated in embodiments having an adjustable chute. The lower trap doors 38 are hinged on pivot rods; in embodiments with an adjustable chute pivot rods may be connected to the front and rear sliding frames so that door support levers move with the adjusting width and the doors can be replaced with appropriately sized doors for the chute width. Under the bale bag 42 there is a moving platform 44 that is driven vertically by a pneumatic actuator from an upper position to a lower position to act as a cushion so the group of packages 22 can be received in the bale bag 42 with limited damage to the product. After this, a pusher plate 46 moves from a retracted to an extended position to push the loaded bale bag 42 horizontally towards and onto an exit conveyor 48, such as an endless loop conveyor. The pusher plate 46 is carried by a reciprocating arm driven by a double acting pneumatic actuator. The exit conveyor 48 is located behind the machine on legs. The pusher plate 46 and exit conveyor 48 form part of a transport mechanism, denoted generally by reference 47, of an overall baling system of which the baling machine 20 forms a part. The conveying surface is level with the moving platform 44 when it is in its lowered position. In the illustrated embodiment, while the bag is moving, the top of the bag is driven upwards by a bag conditioner 50 and secured by a bag tying machine, indicated by numeral 51. The bag conditioner has vaned wheels 296, 298 where each of the wheels have a solid hub to which is fixed a plurality of flat flexible vanes to promote air flow and deflect the bag upwardly so it is ready for the bag tying machine 51. In other embodiments the bag conditioner is replaced with bag top grippers which support the bag top and transfer the bag to the closing device. The package counter will be reset and the process will begin over.

In FIG. 2, the loading station 27 is shown in more detail. It is shown that the stop plate 34 is mounted for travel horizontally on stop plate guide rods 66 and 68 that run above and to either side of the upper trap doors 28, 30 by way of a support 70. In the illustrated embodiment, the upper trap doors 28, 30 are controlled by an actuator with an electric motor and gear combination located in housing 60 behind the stop plate 34. In other embodiments the upper trap doors 28, 30 are actuated by pneumatic cylinders. The upper trap doors 28, 30 pivot on upper door pivots 56, 58 which run parallel to the sides of the chute 36. The package sensor 54 is secured so that it moves with the stop plate 34. In alternate embodiments with an adjustable chute, the stop plate guide rods may have adjustable stops to correspond to the size of the packages so that a package will be located over the centre of the chute 36 when in contact with the stop plate 34. The loading station has guide fences 62, 64 to locate the packages over the doors.

Referring back to FIG. 1, as the baling machine is operating and filling the chute 36, there is a bag supply apparatus (not shown) below the lower trap doors 38 which operates to pull a bag across the chute opening in preparation for receiving a group of product bags when the lower trap doors 38 open. The lower trap doors are moved from a closed position to an open position via pneumatic actuators. The bag supplying apparatus has a bag blower (not shown) to blow into the bale bags one at a time to ensure that the bale bag is open.

The pusher plate 46 pushes the bale bags onto the exit conveyer and is only operated when the moving platform 44 is in its lowest position. The bottom of the pusher plate is aligned with an aperture defined by an end of the moving platform 44, the platform support rod (not shown), and the platform supports apparatus (not shown). The moving platform 44 is able to move vertically without interfering with the pusher plate 46. There is a U-shaped element with two horizontal arms projecting from a pusher plate support apparatus 43 that provides support for the pusher plate from behind a bag support fence 53. The pusher plate support apparatus 43 is carried by a reciprocating arm (not shown) of the baling machine 20; the reciprocating arm reciprocates forward and backward and thereby moves the pusher plate 46 between the retracted and the extended position. The bag support fence 53 is provided to prevent filled bags from falling off the side of the platform. There is no fence on the other side because there needs to be full access for bag blowing. From the left side of the exit conveyor 48 there is a vertical post 55 that extends to support the end of the bag support fence 53. At the top of the post 55 there is a support bar which supports the bag conditioner 50 and the bag tying machine 51.

According to the present disclosure, a baling system, such as the exemplary baling system described above, may be modified for use in accumulating packages for binding operations instead of baling operations. The modification may include replacing the bag conditioner and the bag tying machine with a binding machine, removing the bag supply apparatus, bag holder grip and the moving platform and modifying the transport mechanism, as will be explained in more detail below. In particular, as part of the modification to the transport mechanism, the pusher plate is replaced with a magazine.

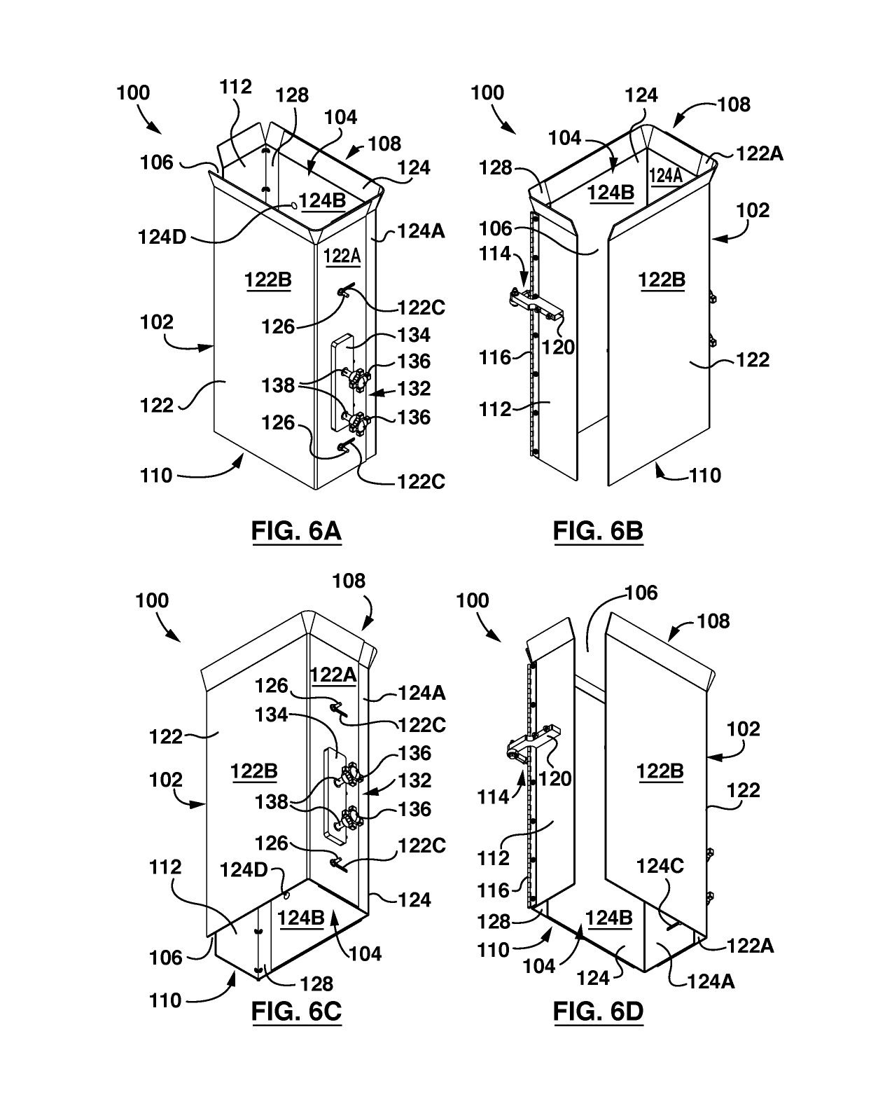

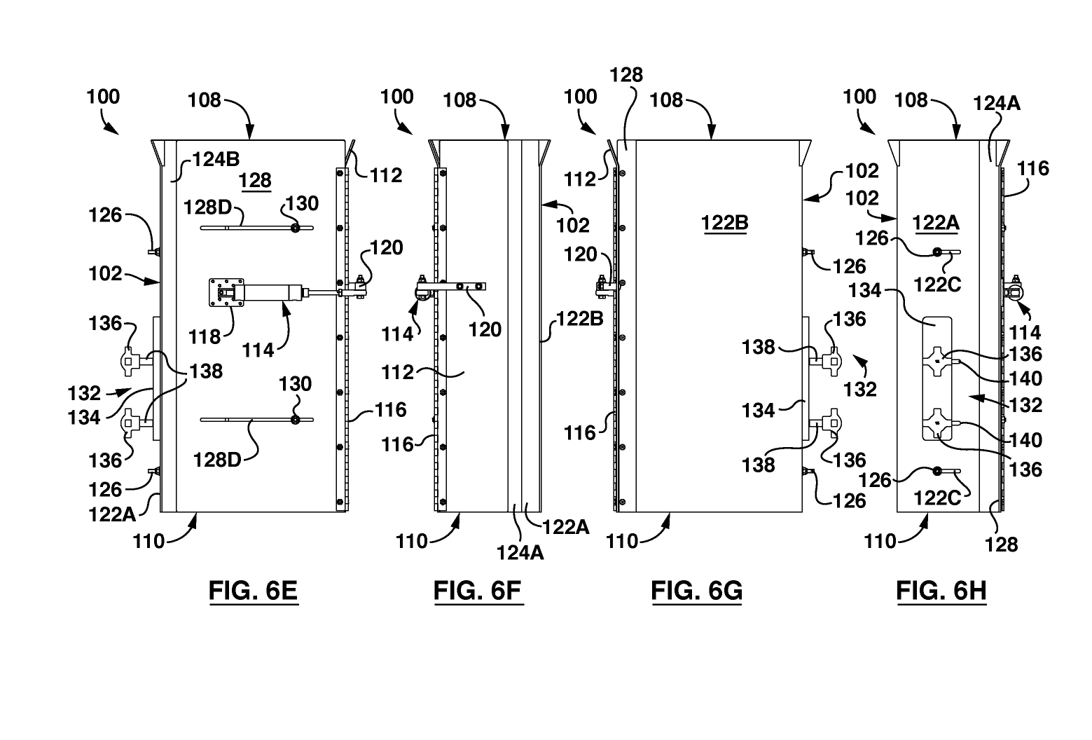

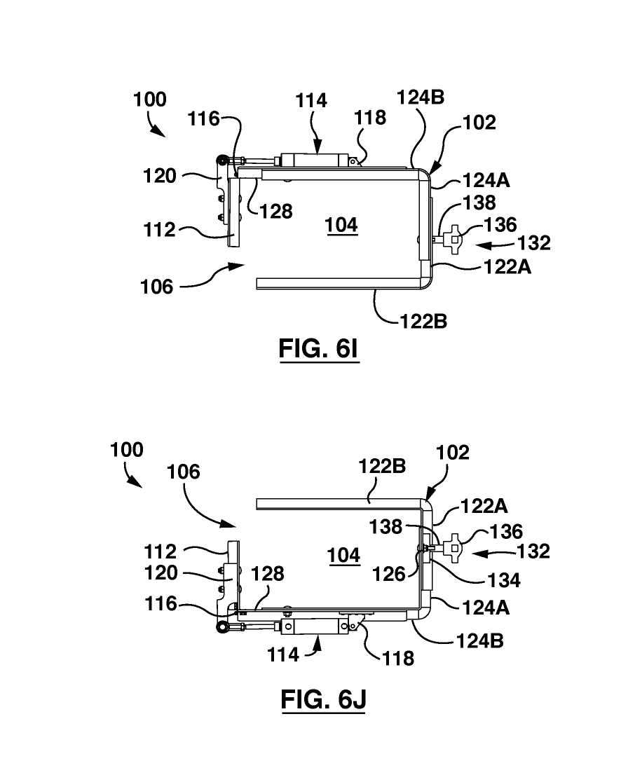

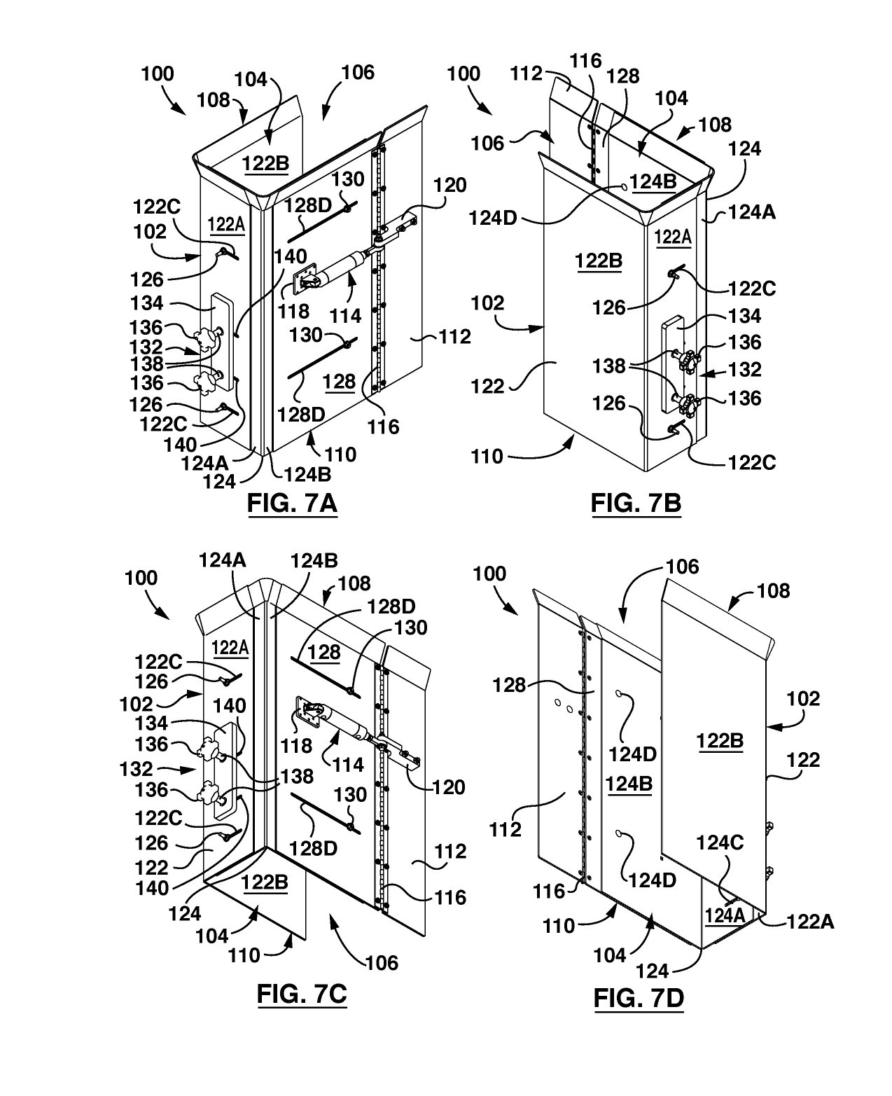

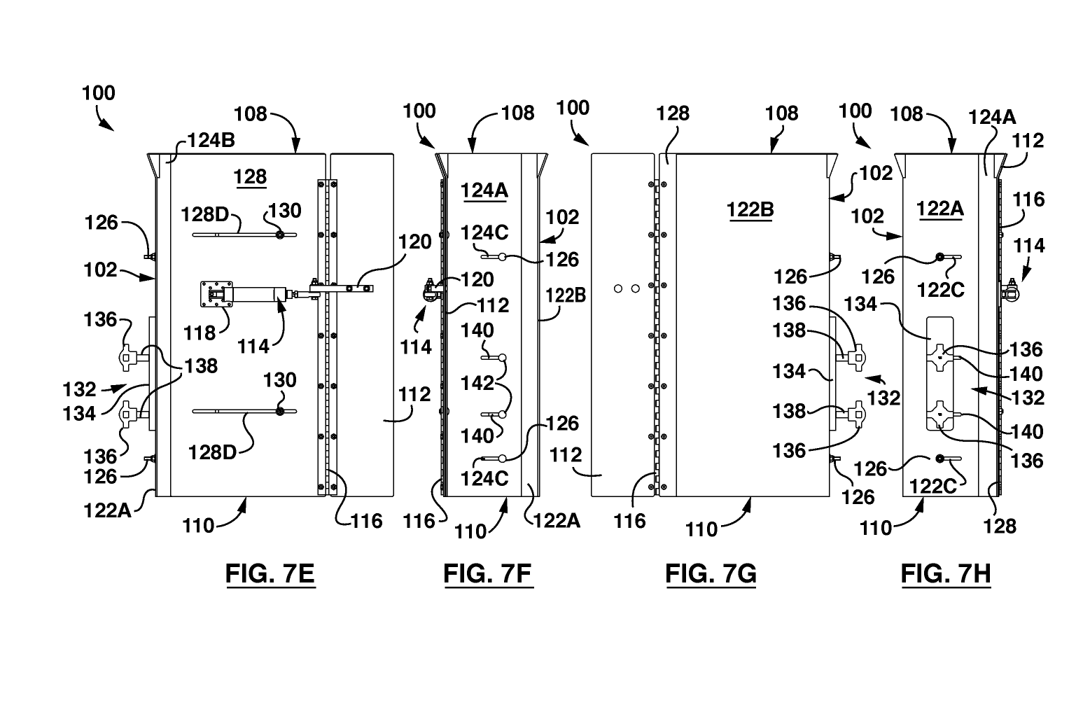

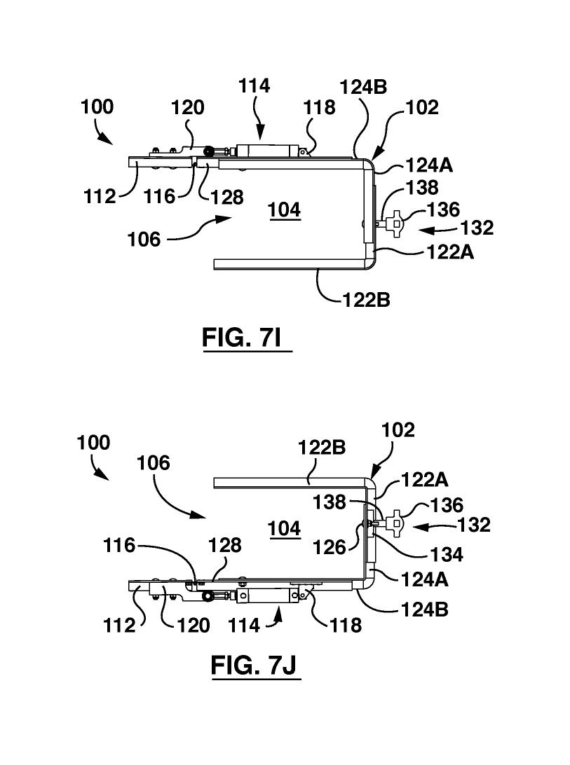

Reference is now made to FIGS. 6A to 7J, which show an exemplary magazine, indicated generally by reference 100, that may be used to replace the pusher plate so as to enable transfer of a stack of filled bags or similar packages from an accumulator chute, such as the chute 36 of the baling machine 20 described above, to a conveyor. It is to be appreciated that the magazine 100 shown in the drawings is merely exemplary, and that magazines having other designs and structures may also be used. The magazine 100 comprises a partial tube 102 forming a channel 104 having a longitudinally extending discharge opening 106. The channel 104 extends between an open superior end 108 of the partial tube 102 and an open inferior end 110 of the partial tube 102; the partial tube 102 is outwardly flared at the open superior end 108. A gate 112 is movably carried by the partial tube 102 so as to be movable, relative to the partial tube 102, between a closed position in which the discharge opening 106 is obstructed by the gate 112, as shown in FIGS. 6A to 6J, and an open position in which the discharge opening 106 is unobstructed by the gate 112, as shown in FIGS. 7A to 7J. As can be seen in the Figures, the gate 112 need not extend entirely across the discharge opening 106 in order to effectively obstruct the discharge opening 106. An actuator 114 acts between the partial tube 102 and the gate 112 to move the gate 112 between the open position and the closed position. In the illustrated embodiment, the gate 112 is hinged to the partial tube 102 by a hinge 116 and the actuator 114 comprises a double acting pneumatic actuator coupled to the partial tube 102 by a hinge plate 118 and coupled to the gate 112 by a hinge arm 120; other suitable actuators may be used instead of a pneumatic actuator. For example, a hydraulic actuator, a solenoid or a motor and gear arrangement may be used although these are less preferred. In other embodiments, the gate may be movably coupled to the partial tube other than by hinging, for example where sufficient space is available the gate may be slidably mounted to the partial tube so as to be slidable between the open position and the closed position.

In the illustrated embodiment, the partial tube 102 is of adjustable size. The partial tube 102 is formed from two generally L-shaped panels 122, 124 whose shorter sides or arms 122A, 124A overlap and whose longer sides or stems 122B, 124B extend substantially parallel to one another. The arms 122A, 124B of the L-shaped panels 122, 124 each have respective spaced-apart width-adjustment slots 122C, 124C; when the arms 122A, 124A overlap with their inferior and superior ends aligned as shown in the drawings, the width-adjustment slots 122C, 124C will be arranged in registration with one another. Nut and bolt assemblies 126 are used to fasten the arms 122A, 124A of the L-shaped panels 122, 124 together to form the partial tube 102. The width-adjustment slots 122C, 124C allow the stems 122B, 124B of the L-shaped panels 122, 124 to be moved toward or away from one another before the bolts are tightened, thereby permitting the width of the partial tube 102 to be adjusted to accommodate bags or similar packages of varying widths. Similarly, the length of the partial tube 102 may be adjusted by way of a generally planar extension panel 128 which has length-adjustment slots 128D and correspondingly positioned bolt apertures 124D on the stem 124B of one of the L-shaped panels 124. Nut and bolt assemblies 130 are used to fasten the extension panel 128 to the stem 124B of the L-shaped panel 124, and the length-adjustment slots 128D allow the extension panel 128 to be moved toward or away from the arms 122A, 124A of the L-shaped panels 122, 124 before tightening the bolts, enabling the length of the partial tube 102 to be adjusted to accommodate bags or similar packages of varying lengths. The gate 112 is hinged to the extension panel 128, which also carries the hinge plate 118 and actuator 114, so that adjustment of the position of the extension panel 128 will also automatically adjust the position of the gate 112. A magazine 100 whose partial tube 102 is of adjustable size, such as the exemplary embodiment described above, may be used with a baling machine whose chute is of adjustable size. In other embodiments, the partial tube may be only width-adjustable, only length-adjustable, or may be of fixed size.

An arm mounting fixture 132 is disposed on the partial tube 102 to couple the magazine 100 to the reciprocating arm of the baling machine with which the magazine will be used. In the illustrated embodiment, the mounting fixture 132 is disposed opposite the discharge opening 106, on the arm 122A of the outermost L-shaped panel 122. The exemplary mounting fixture 132 shown in the drawings comprises a support plate 134 and two mounting knobs 136 having threaded shafts 138 received in corresponding apertures extending through the support plate 134. The threaded shafts 138 extend beyond the support plate 134 through positioning slots 140 formed through the arms 122A, 124A and receive bolts 142. The mounting knobs 136 are positioned for coupling to the U-shaped element projecting from the pusher plate support apparatus of a baling machine so that the magazine 100 is mounted to the reciprocating arm of the baling machine. The positioning slots 140 allow the distance of the magazine 100 from the baling machine to be adjusted, for example to ensure that the magazine 100 is centered under the chute after its size has been adjusted. The illustrated embodiment is merely one non-limiting example of a mounting fixture, and a wide variety of mounting fixtures may be used, depending on the structure of the pusher plate support apparatus of the particular baling machine with which the magazine will be used.

Similarly, in other embodiments the mounting fixture may be disposed elsewhere than opposite the discharge opening, again depending on the structure of the pusher plate support apparatus of the particular baling machine.

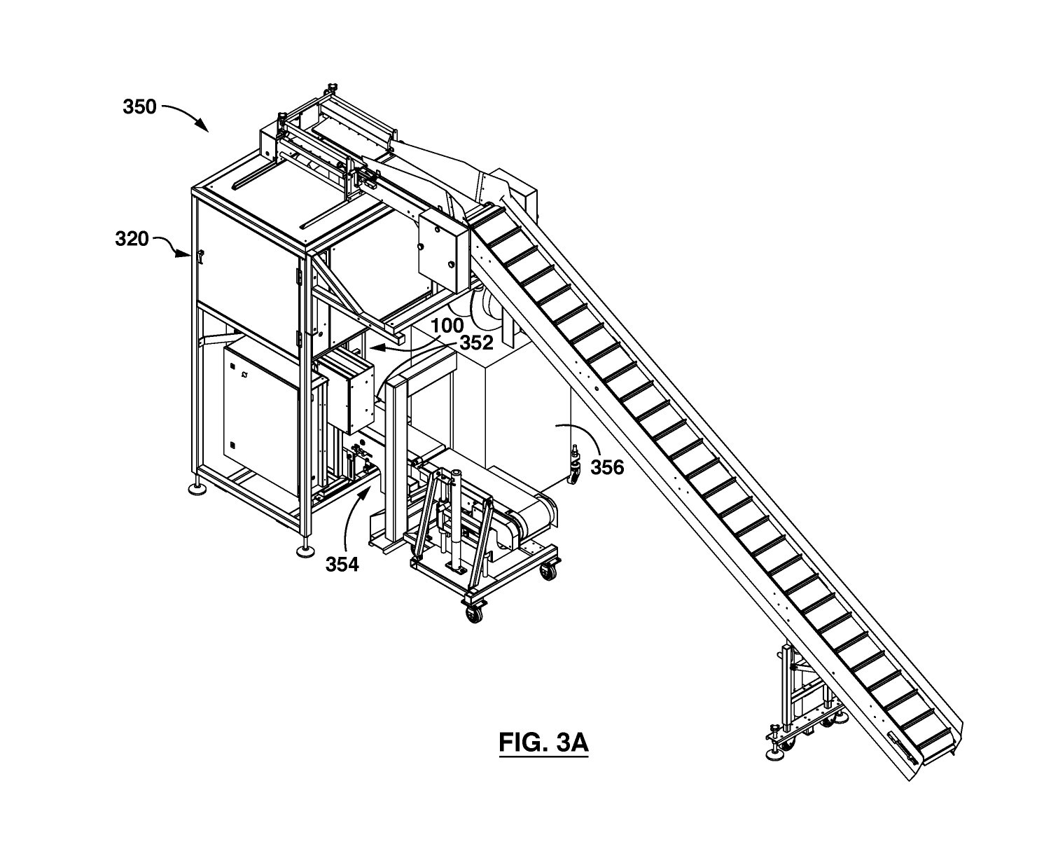

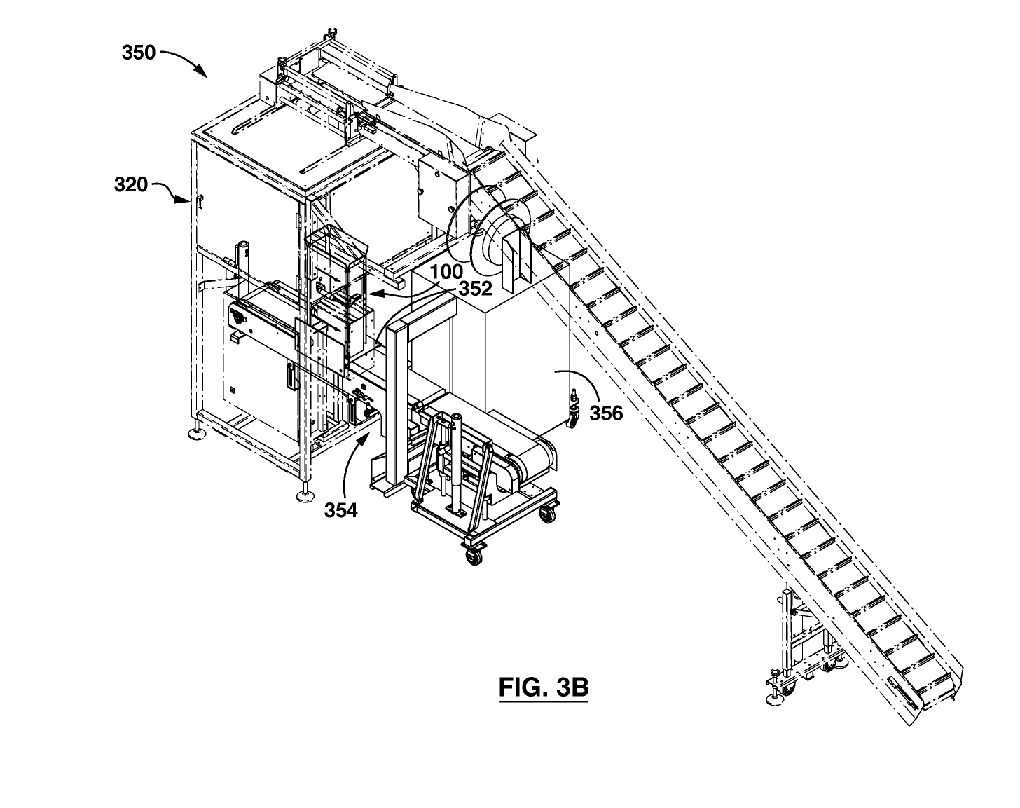

Referring now to FIGS. 3A and 3B, a magazine according to the present disclosure may form part of an apparatus, indicated generally by reference 350, for binding a plurality of packages together. The apparatus 350 comprises, in addition to the magazine 100, a baling machine 320, a baseplate 352 spaced from and in registration with a lower opening of the chute of the baling machine 320, an exit conveyor 354 and a strapping machine 356. FIG. 3A shows the baling machine 320 in solid lines, while FIG. 3B shows the baling machine 320 as transparent so as to expose the relative positioning of the magazine 100 and the baseplate 352. The baling machine 320 is similar in construction to the baling machine 20 described above and may be, for example, the Adjustable Master Ice Baler offered as product number IB-1008 by Johnsen Machine Company Ltd. Since the general construction and principles of operation of an exemplary baling machine have been described above, particular details of the exemplary baling machine 320 shown in FIGS. 3A and 3B are not described further. The strapping machine 356 may be, for example, an automatic strapping machine sold under model number RQ-8Y by Samuel Strapping Systems, a wholly owned Division of Samuel, Son & Co., Limited having an address at 2360 Dixie Road, Mississauga, Ontario, Canada L4Y 1Z7. While a particular strapping machine 356 is shown and described for purposes of illustration, this is merely exemplary, and other types of strapping machines may be used. Moreover, a strapping machine is merely one example of a binding machine, and one skilled in the art, now informed by the present disclosure, will appreciate that the apparatus, systems and methods described herein may be adapted for use with any suitable binding machine, including not only strapping machines but also banding machines and wrapping machines.

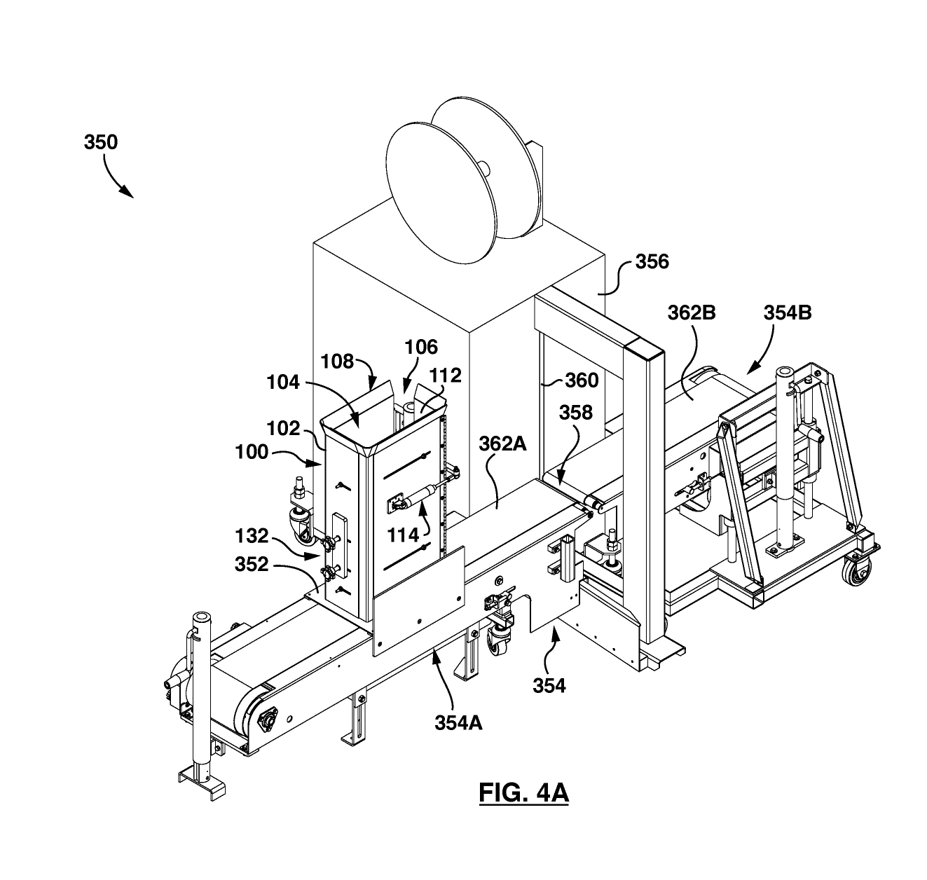

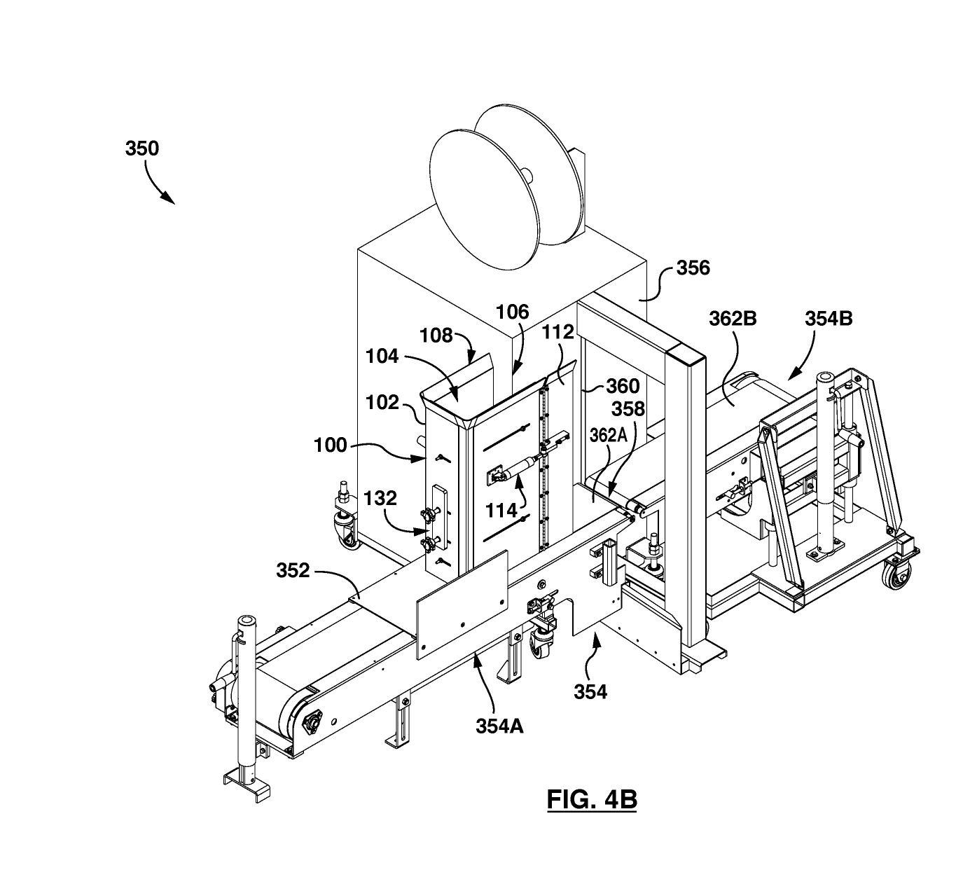

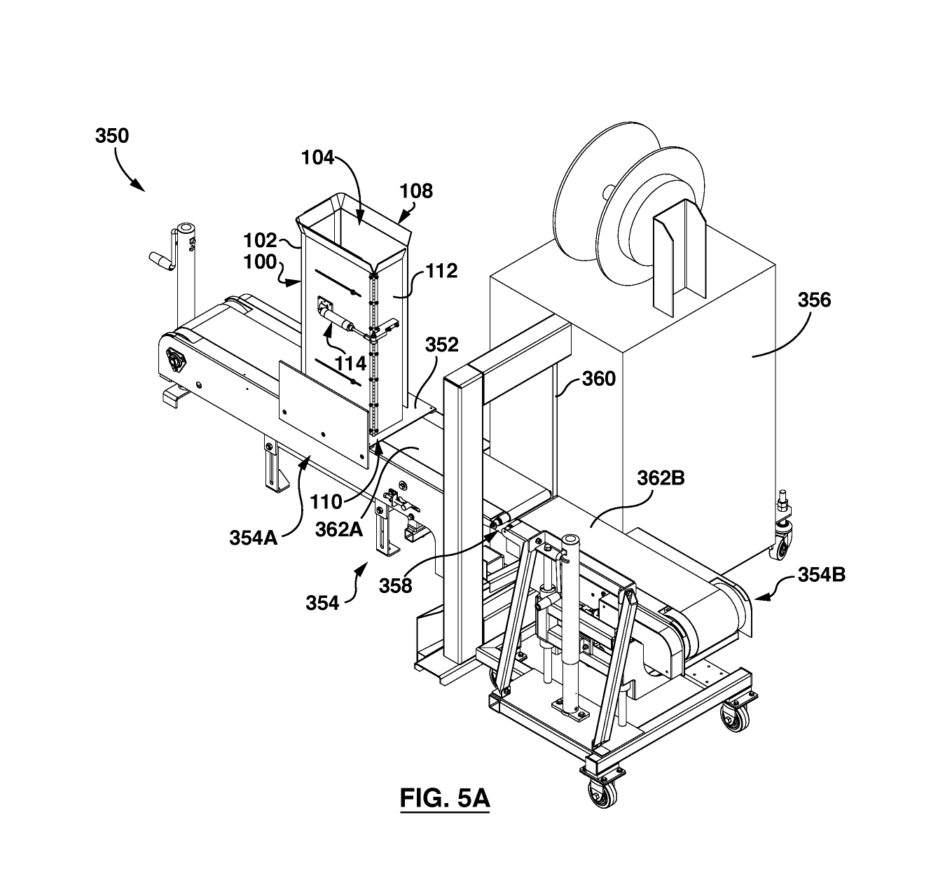

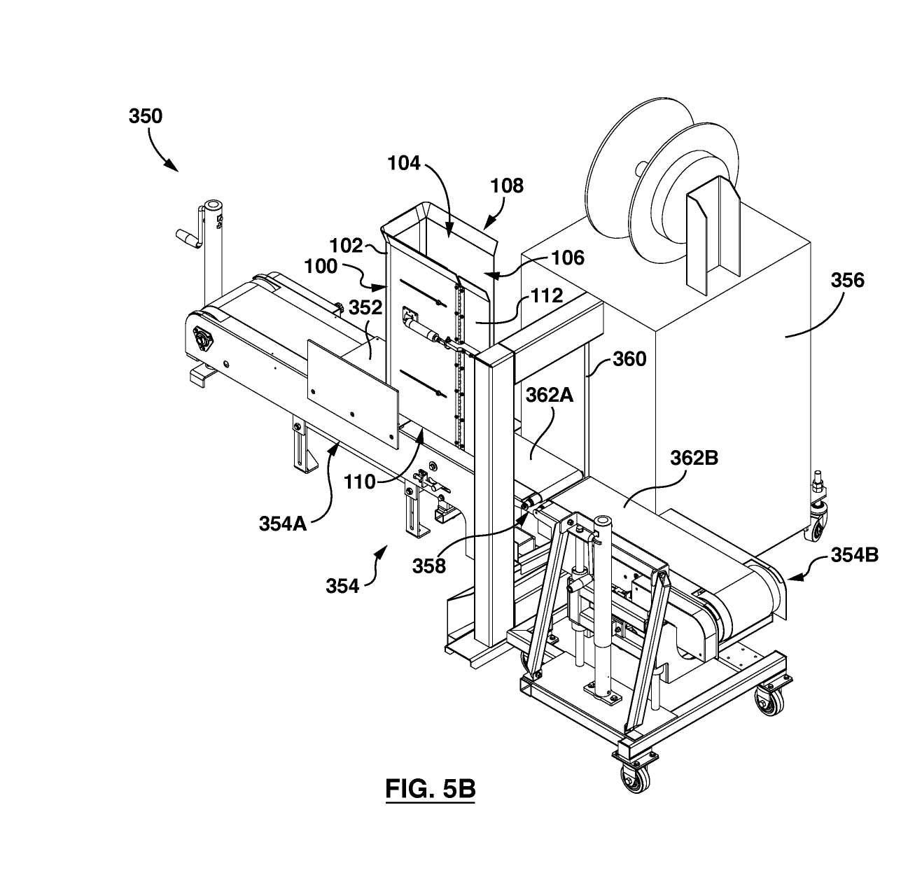

In the apparatus 350, the magazine 100 is mounted by way of the arm mounting fixture 132 (not visible in FIGS. 3A and 3B) to the reciprocating arm of the baling machine 320. The magazine 100 is mounted so that the channel 104 and the discharge opening 106 extend substantially vertically and so that the magazine 100 is movable, relative to the baling machine 320 and the exit conveyor 354, between a receiving position and a discharge position (see FIGS. 4B and 5B).

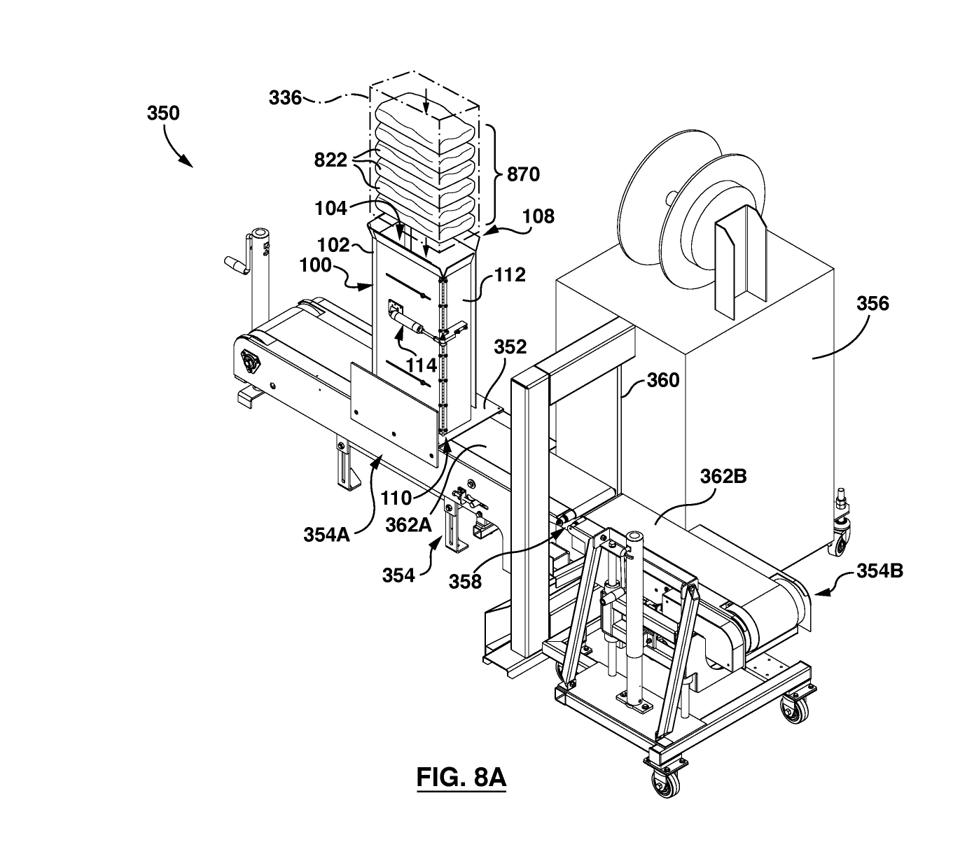

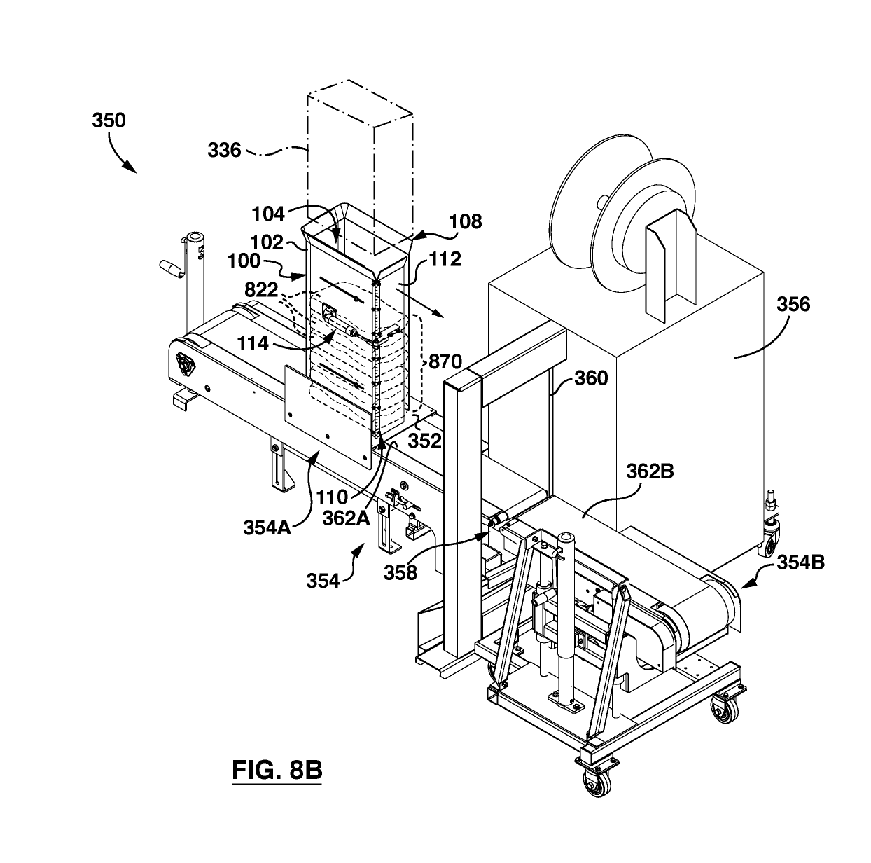

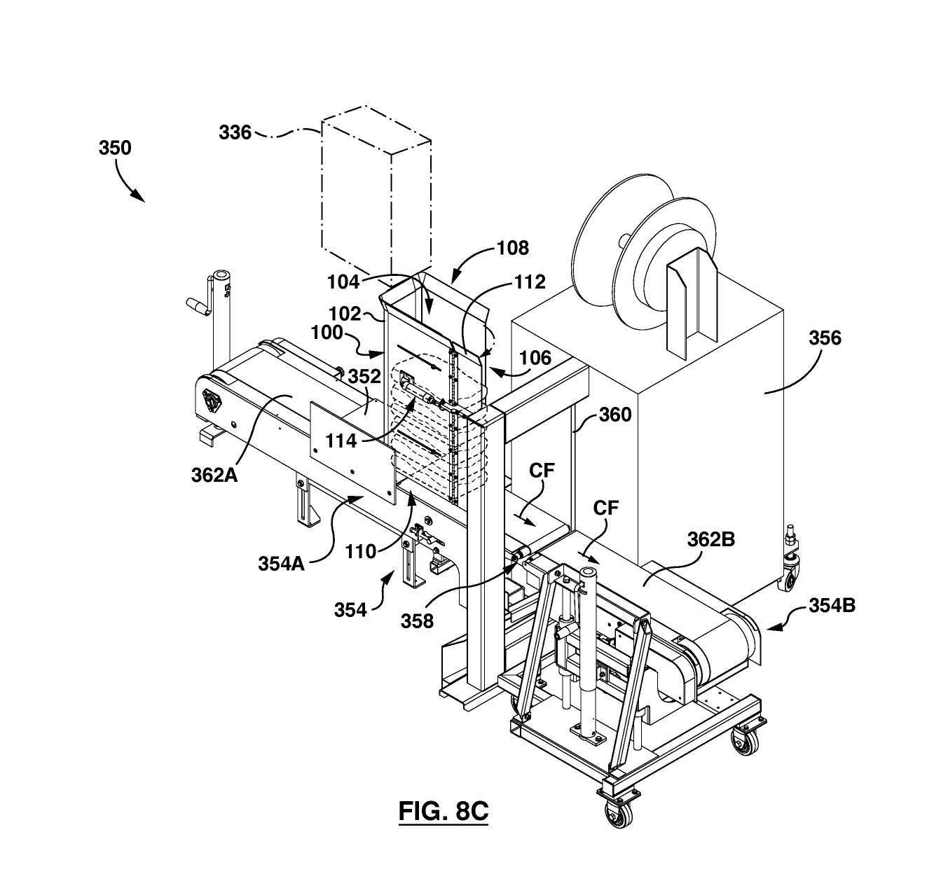

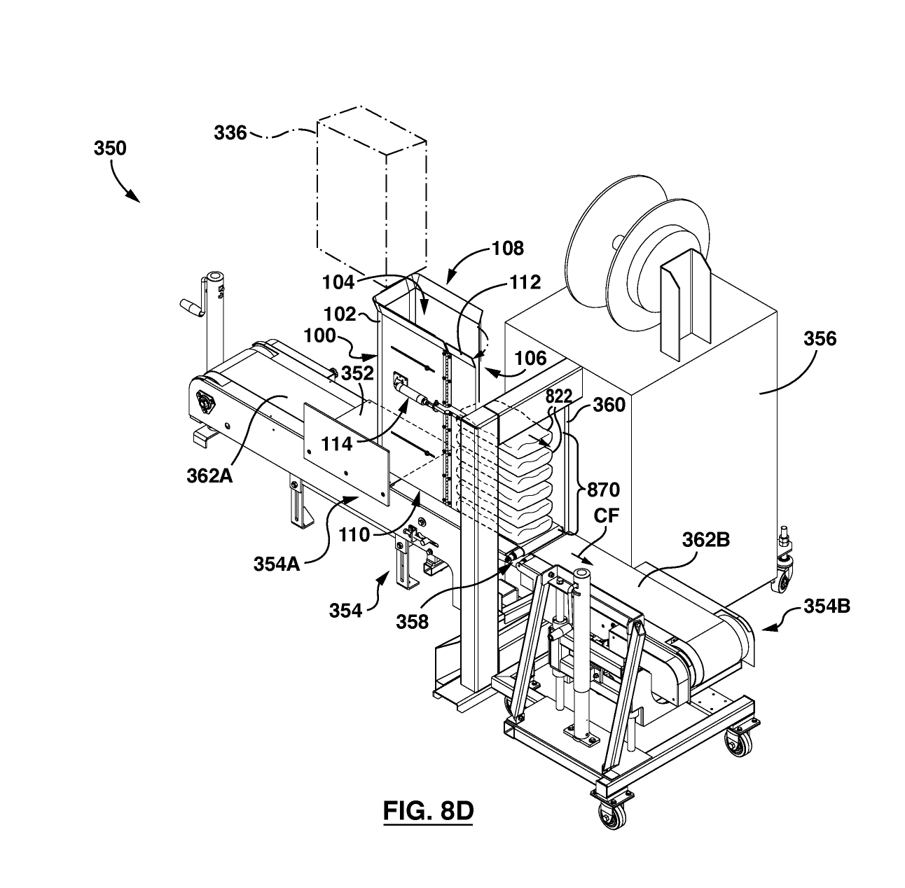

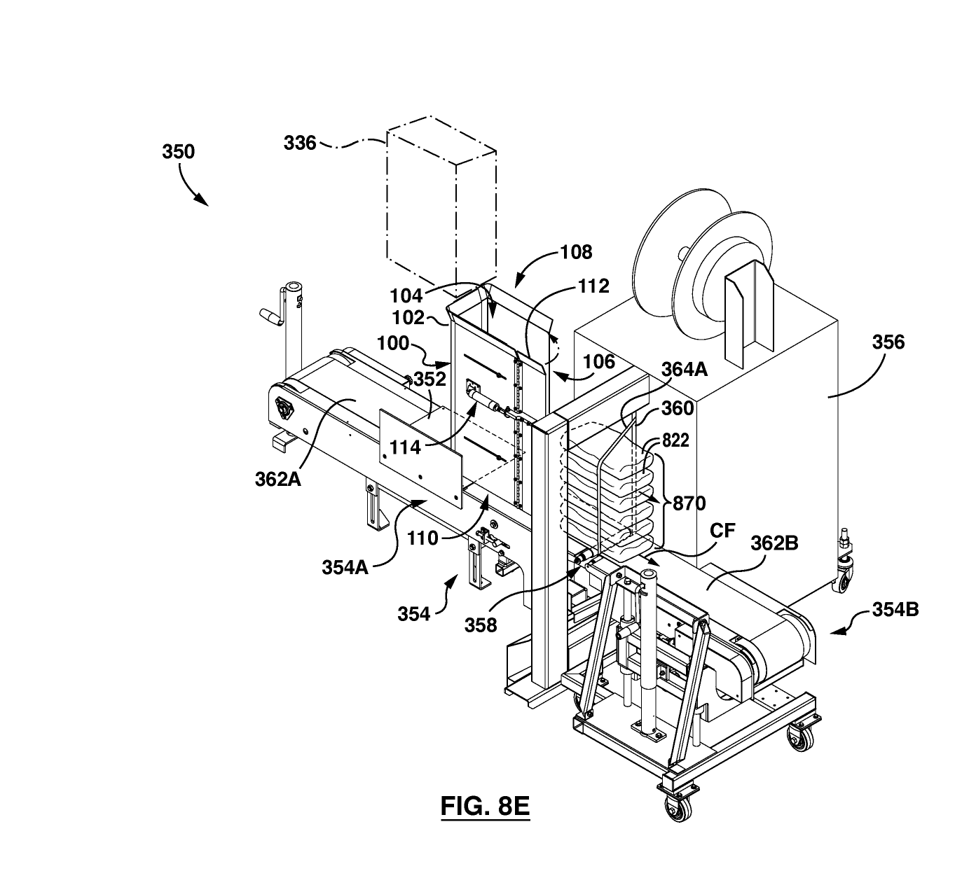

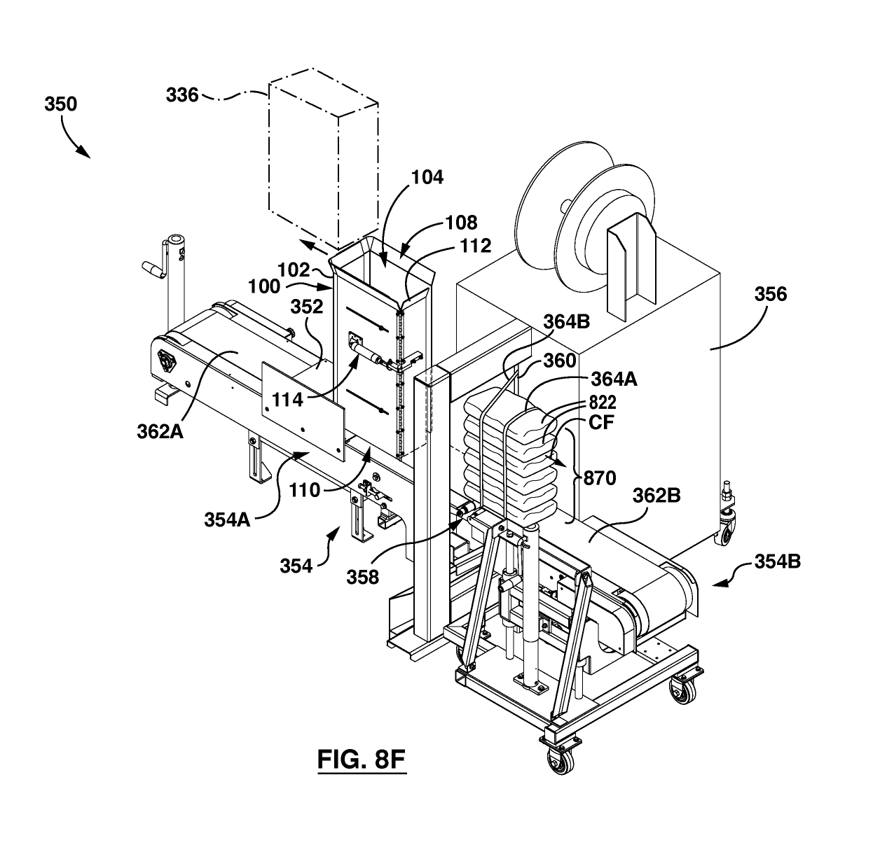

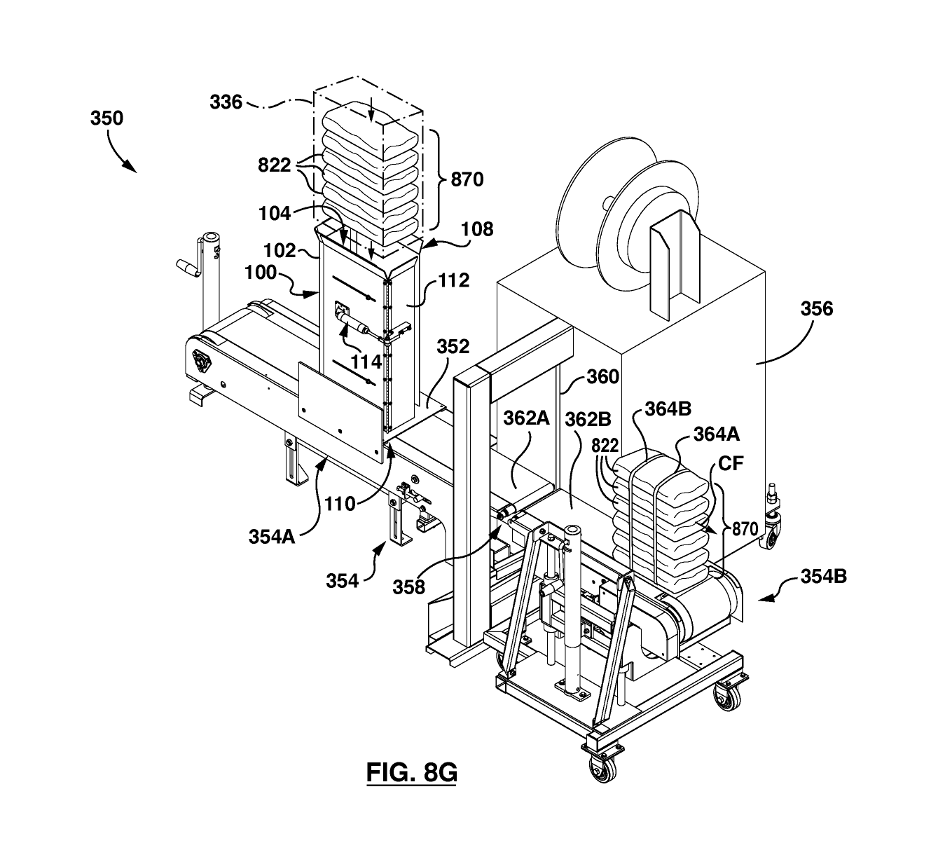

Reference is now made to FIGS. 4A to 5B, which show the apparatus 350 with the baling machine 320 removed so as to provide better visibility of the magazine 100, baseplate 352, exit conveyor 354 and strapping machine 356. As can be seen in FIGS. 4A and 5A, when the magazine 100 is in the receiving position, the open superior end 108 of the partial 102 tube and the open inferior end 110 of the partial tube 102 are in registration with the baseplate 352. In addition, when the magazine 100 is in the receiving position the open superior end 108 of the partial tube 102 and the open inferior end 110 of the partial tube 102 are also in registration with the lower opening of the chute 336 of the baling machine 320 (see FIGS. 8A and 8B). As can be seen in FIGS. 4B and 5B, when the magazine 100 is in the discharge position, the open superior end 108 of the partial tube 102 and the open inferior end 110 of the partial tube 102 are out of registration with the baseplate 352 and in registration with the exit conveyor 354. In the illustrated embodiment, the baseplate 352 is positioned over top of a portion of the exit conveyor 354 in overlapping relation therewith so that the exit conveyor 354 extends beneath and beyond the baseplate 352. In other embodiments the baseplate may be positioned upstream of the exit conveyor so long as any gap between the baseplate and the exit conveyor is sufficiently small to keep bags or similar packages from falling through or becoming lodged in the gap as the magazine moves from the receiving position to the discharge position.

Continuing to refer to FIGS. 4A to 5B, in the illustrated embodiment the exit conveyor 354 comprises an upstream conveyor segment 354A and a downstream conveyor segment 354B. The upstream conveyor segment 354A and the downstream conveyor segment 354B are spaced from one another to define a binding gap 358 between the upstream conveyor segment 354A and the downstream conveyor segment 354B. The strap outlet 360 of the strapping machine 356 is positioned in registration with the binding gap 358 so that straps emitted by the strapping machine 356 can pass through the binding gap to wrap around a stack of packages.

Reference is now made to FIGS. 8A to 8G, which show the apparatus 350 in operation, again with the baling machine 320 removed so as to provide better visibility of the magazine 100, baseplate 352, exit conveyor 354 and strapping machine 356. Thus, FIGS. 8A through 8G illustrate a method for binding a plurality of filled packages.

Referring first to FIG. 8A, a stack 870 of filled packages 822 accumulates in the chute 336 (shown schematically with dashed lines in FIGS. 8A to 8G) of the baling machine 320 (not shown in FIGS. 8A to 8G). As can be seen, the chute 336 is disposed above and in registration with the upstream conveyor segment 354A of the conveyor 354, and the baseplate 352 is disposed above the upstream conveyor segment 354A in registration with the chute 336.

Now referring to FIG. 8B, after the stack 870 of filled packages 822 has accumulated in the chute 336, the stack 870 of bags 822 is released from the chute 336 (e.g. by opening the lower trap doors) to pass into the magazine 100 via the open superior end 108 thereof. As can be seen in FIG. 8B, when the stack 870 of filled packages 822 is released, the magazine 100 is in the receiving position and is disposed between the chute 336 and the baseplate 352 and in registration with the chute 336 and the baseplate 352, with the gate 112 in the closed position. As a result, when the stack 870 of filled packages 822 is released from the chute 336, the stack 870 of filled packages 822 comes to rest on the baseplate 352 inside the magazine 100 (since the inferior end 110 of the magazine 100 is open).

With reference now to FIG. 8C, once the stack 870 of filled packages 822 comes to rest on the baseplate 352 inside the magazine 100, the magazine 100 moves in a conveyor-forward direction (denoted by arrows CF). Movement of the magazine 100 in the conveyor-forward direction CF moves the stack 870 of filled packages 822 off the baseplate 352 onto a conveyor surface 362A of the upstream conveyor segment 354A, and the stack 870 of filled packages 822 is released from the magazine 100 to move along the upstream conveyor segment 354A in the conveyor-forward direction CF toward the strapping machine 356. In the illustrated embodiment, the magazine 100 is moved in the conveyor-forward direction CF by the reciprocating arm of the baling machine 320 (not shown in FIGS. 8A to 8G), which moves the magazine 100 from the receiving position to the discharge position. Also in the illustrated embodiment, the stack 870 of filled packages 822 is released from the magazine 100 by moving the gate 112 thereof from the closed position to the open position. The gate 112 may be moved to the open position either before, during or after movement of the magazine 100 from the receiving position to the discharge position, and may be coupled to a control system of the apparatus 350 to control timing of movement of the gate 112 between the closed position and the open position. Since the inferior end 110 of the magazine 100 is open, the stack 870 of filled packages 822 will come to rest on the moving conveyor surface 362A after being pushed off the baseplate 352. This allows the upstream conveyor segment 354A to carry the stack 870 of filled packages 822 out of the magazine 100 through the discharge opening 106 once the gate 112 is open.

Thus, with reference now to FIG. 8D, once released from the magazine 100, the stack 870 of filled packages 822 moves along the upstream conveyor segment 354A in the conveyor-forward direction CF toward the strapping machine 356. In particular, the stack 870 of filled packages 822 moves toward the binding gap 358 between the upstream conveyor segment 354A and the downstream conveyor segment 354B of the conveyor 354.

Referring now to FIGS. 8E and 8F, as the stack 870 of filled packages 822 moves across the binding gap 358, it passes in front of the strap outlet 360 of the strapping machine 356; as noted above the strap outlet 360 is positioned in registration with the binding gap 358 so that straps emitted by the strapping machine 356 can pass through the binding gap 358. As the stack 870 of filled packages 822 crosses the binding gap 358 onto the moving conveyor surface 362B of the downstream conveyor segment 354B, the upstream conveyor segment 354A and the downstream conveyor segment 354B stop when the stack 870 of filled packages 822 is at a first predetermined position straddling the binding gap 358, under control of a sensor and/or timing system. The strapping machine 356 then applies a first strap 364A, as shown in FIG. 8E. After the first strap 364A is applied, the upstream conveyor segment 354A and the downstream conveyor segment 354B restart, index the stack 870 of filled packages 822 forward to a second predetermined position straddling the binding gap 358, and then stop. The strapping machine 356 then applies a second strap 364B, as shown in FIG. 8F, to bind the stack 870 of filled packages 822 together. The stack 870 of filled packages 822, now bound together by the straps 364A, 364B, continues along the downstream conveyor segment 354B, as shown on FIG. 8G, for packing or further processing.

While the strapping operation shown in FIGS. 8E and 8F is underway, the gate 112 of the magazine 100 is closed and the magazine 100 is returned by the reciprocating arm of the baling machine 320 to the receiving position to receive another stack 870 of filled packages 822 that has accumulated in the chute 336 of the baling machine 320, as shown in FIG. 8G.

Certain currently preferred embodiments have been described by way of non-limiting example. The baling machine described herein is merely one exemplary baling machine shown and described for purposes of illustration, and the teachings of the present disclosure are not limited thereto. Similarly, the magazine described herein is merely one exemplary magazine, and is not intended to be limiting. The teachings of the present disclosure may be applied to and in respect of other types of baling machine and using other types of magazine. It will be apparent to persons skilled in the art that a number of variations and modifications can be made without departing from the scope of the claims.

What is claimed is:

1. A magazine for transferring a stack of bags from an accumulator chute to a conveyor, the magazine comprising:
a partial tube forming a channel having a longitudinally extending discharge opening;
the channel extending between an open superior end of the partial tube and an open inferior end of the partial tube;
a gate movably carried by the partial tube so as to be movable, relative to the partial tube, between:
a closed position in which the discharge opening is obstructed by the gate; and
an open position in which the discharge opening is unobstructed by the gate;
at least one actuator acting between the partial tube and the gate and adapted to move the gate between the open position and the closed position; and
an arm mounting fixture on the partial tube, the arm mounting fixture being adapted for mounting the magazine to a reciprocating arm of a baling machine.

2. The magazine of claim 1, wherein the gate is hinged to the partial tube.

3. The magazine of claim 1, wherein the mounting fixture is disposed opposite the discharge opening.

4. An apparatus for binding a plurality of packages together, the apparatus comprising:
a baling machine;
a baseplate spaced from and in registration with a lower opening of a chute of the baling machine;
an exit conveyor; and
the magazine of claim 1;
wherein:
the magazine is mounted by way of the arm mounting fixture to a reciprocating arm of the baler so that the channel and the discharge opening extend substantially vertically and so that the magazine is movable, relative to the baler and the exit conveyor, between:
a receiving position in which the open superior end of the partial tube and the open inferior end of the partial tube are in registration with the baseplate and with the lower opening of the chute of the baler; and
a discharge position in which the open superior end of the partial tube and the open inferior end of the partial tube are out of registration with the baseplate and in registration with the exit conveyor.

5. The apparatus of claim 4, wherein:
the exit conveyor comprises an upstream conveyor segment and a downstream conveyor segment;
the downstream conveyor segment being spaced from the upstream conveyor segment to define a binding gap between the upstream conveyor segment and the downstream conveyor segment;
the apparatus further comprising a binding machine positioned at the binding gap.

6. The apparatus of claim 5, wherein:
the binding machine is a strapping machine; and
wherein a strap outlet of the strapping machine is positioned in registration with the binding gap so that straps emitted by the strapping machine can pass through the binding gap.

7. A method for binding a plurality of filled packages, the method comprising:
accumulating a stack of filled packages in a chute, wherein:
the chute is disposed above and in registration with a conveyor; and
a baseplate is disposed above the conveyor in registration with the chute;
releasing the stack of filled packages from the chute into a magazine, wherein the magazine is disposed between the chute and the baseplate and in registration with the chute and the baseplate when the stack of filled packages is released from the chute, so that the stack of filled packages rests on the baseplate inside the magazine;
moving the magazine in a conveyor-forward direction to move the stack of filled packages off the baseplate onto a conveyor surface of the conveyor; and
releasing the stack of filled packages from the magazine to move along the conveyor in the conveyor-forward direction toward a binding machine.

8. The method of claim 7, wherein the binding machine is a strapping machine.
